(19) United States
(12) Patent Application Publication
(10) Pub. No.: US 2006/0215034 A1
(43) Pub. Date: Sep. 28, 2006

(54) Imaging device

(75) Inventors: Kiyotaka Nakabayashi, Tokyo (JP); Nobuyuki Sato, Tokyo (JP); Ken Nakajima, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/551,799

(22) PCT Filed: Mar. 12, 2004
(86) PCT No.: PCT/JP04/03346

§ 371 Date: Sep. 27, 2005

(30) Foreign Application Priority Data
Mar. 28, 2003 (JP) 2003-090611

(51) Int. Cl. H04N 9/04; H04N 9/73; H04N 5/225

(52) U.S. Cl. 348/207.99; 348/224.1

(57) ABSTRACT

When color correction is performed on a particular color of a video signal, in order to change a color correction amount according to image-taking circumstances or capture video images without influencing colors not to be corrected, image-taking mode information containing information on particular colors determined according to predetermined image-taking conditions is set. There are provided selection means for selecting desired image-taking mode information from the image-taking mode information, and storage means for storing color convergence parameter values containing position data indicative of a position of a predetermined color in a color-difference plane, correction range setting data for setting to a correction range a predetermined range centered at the position of the predetermined color, and convergence coefficient data for converging a particular color corresponding to the correction range to the position indicative of the predetermined color. Color convergence parameter values for the corresponding particular color from the storage means is selected and set on the basis of the selected image-taking mode information, and a particular color in a video signal is corrected into the predetermined color on the basis of a correction amount calculated on the basis of the set color convergence parameter values.

### TECHNICAL FIELD

The present invention relates to an image capture apparatus and, more specifically, to an image capture apparatus which is capable of correcting a particular color in a video signal into a predetermined color such as a memory color.

### BACKGROUND ART

In the prior art, there exists an apparatus such as a digital camera capable of automatically performing various settings such as focus and white balance and correcting a particular color in a video signal into a predetermined color appropriate for a scene where an image is to be taken, by selecting an image-taking mode (for example, a sea, a night view, a portrait and a landscape) according to the scene where the image is to be taken.

In addition, in the field of such apparatus capable of correcting a particular color in a video signal, there has been invented an image processing device or the like which corrects a particular color into a color, which humans latently memorize and feel to be the most beautiful, i.e., a so-called memory color. (For example, refer to Japanese Patent Application Publication Number 2001-292390 (Pages 3-5, FIG. 5)).

In such apparatus, for example, when a user takes an image of a landscape containing a blue sky, the blue color (particular color) of the actually taken image is corrected into a blue color based on a memory color, because when the user views the taken image, the user usually imagines a more vivid blue color than the color of the blue sky that the user actually viewed.

The present applicant has also filed an image capture apparatus which is capable of extracting from a captured video signal a video signal of a particular color to be corrected, calculating a correction amount for the color on the extracted video signal of the particular color, and correcting the particular color to be corrected, on the basis of the calculated correction amount (Patent Application Number 2003-88060).

An operation outline of the color correction processing of the image capture apparatus filed by the present applicant will be described below.

FIG. 8 is a block diagram showing a schematic configuration of essential sections for performing color signal correction processing in the image capture apparatus, which is provided with an image capture lens section 101A, an image capture device 102A, a S/H (Sample/Hold) circuit 103A, an AGC (Automatic Gain Control) circuit 104A, an A/D (Analog/Digital) conversion circuit 105A, a particular-color extraction circuit 106A, a WB (White Balance) circuit 107A, a gamma correction circuit 108A, a signal processing circuit 109A, a color-difference signal correction circuit 110A, an image-taking mode selection circuit 120A, a color correction value setting circuit 130A, and the like.

First, when an image-taking mode is selected by the image-taking mode selection circuit 120A, the particular-color extraction circuit 106A extracts particular-color signals (Rs[red]/Gs[green]/Bs[blue]) which are video signals of a particular color, from video signals (R[red]/G[green]/B[blue]) on the basis of image-taking mode information corresponding to the image-taking mode, and the particular-color signals are corrected for white balance and grayscale by a WB circuit 141A and a gamma correction circuit 142A of a particular-color signal processing section 140A and are converted into a luminance signal Ys and a color-difference signal [Bs−Ys] and a color-difference signal [Rs−Ys] by a signal processing circuit 143A.

Then, a color-difference signal processing circuit 144A of the particular-color signal processing section 140A performs detection of color-difference data from the color-difference signals [Bs−Ys] and [Rs−Ys] transmitted from the signal processing circuit 143A, and transmits the detected color-difference data to the color correction value setting circuit 130A.

Then, the color correction value setting circuit 130A identifies the particular color to be corrected, on the basis of the image-taking mode information from the image-taking mode selection circuit 120A, reads correction reference data for the particular color from a look-up table, and calculates a color correction value for correcting the particular color into a predetermined color (such as a memory color), on the basis of the read correction reference data for the particular color and the color-difference data transmitted from the color-difference signal processing circuit 144A.

Then, the color-difference signal correction circuit 110A corrects the particular color of the video signals (R[red]/G[green]/B [blue]) into the predetermined color (such as a memory color) on the basis of the color correction value calculated by the color correction value setting circuit 130A.

In this manner, the particular color of the video signals is color-corrected into the predetermined color (such as a memory color) according to the image-taking mode so that a video image is reproduced in a color which agrees with the expectation of a user.

However, the above-mentioned image capture apparatus has the problem that when the particular color of the video signals (R[red]/G[green]/B[blue]) is corrected into the particular color (such as a memory color) by the color-difference signal correction circuit 110A, an influence is exerted on a different color which exists in the same quadrant as the particular color to be corrected, in a color-difference plane (two-dimensional coordinates which are represented by a vertical axis indicative of a color difference [R−Y] and a horizontal axis indicative of a color difference [B−Y] that is to say, a color not to be corrected.

Accordingly, a problem to be solved is to provide an image capture apparatus capable of changing, when a particular color of video signals is to be color-corrected, a color correction amount according to an image taking situation or a video image to be taken, without influencing a color not to be corrected.

### DISCLOSURE OF THE INVENTION

To solve the above-mentioned problems, an image capture apparatus according to the present invention is configured as follows.

(1) An image capture apparatus including: image-taking mode selection means in which image-taking mode information containing information on particular colors determined according to predetermined image-taking conditions is set, and which selects desired image-taking mode information from the set image-taking mode information; color convergence parameter storage means which stores color convergence parameter values which contain position data indicative of a position of a predetermined color in a color-difference plane, correction range setting data for setting to a correction range a predetermined range centered at the position of the predetermined color, and convergence coefficient data for converging a particular color corresponding to the correction range to the position indicative of the predetermined color; color convergence parameter setting means which selects and sets color convergence parameter values for the corresponding particular color from the color convergence parameter storage means on the basis of the image-taking mode information selected by the image-taking mode selection means; and color convergence correction processing means which corrects a particular color in a video signal into the predetermined color on the basis of a correction amount calculated on the basis of the color convergence parameter values set by the color convergence parameter setting means.

(2) The image capture apparatus described in (1), characterized in that the correction range setting data of the color convergence parameter storage means is data for setting to the correction range a circular or elliptical range centered at the position of the predetermined color in the color-difference plane.

(3) The image capture apparatus described in (1), characterized in that the color convergence parameter storage means is provided with a function which changes the color convergence parameter values.

(4) The image capture apparatus described in (1), characterized in that the image-taking mode selection means is provided with a function which automatically selects the image-taking mode information according to image-taking environments.

(5) An image capture apparatus including: image-taking mode selection means in which image-taking mode information containing information on particular colors determined according to predetermined image-taking conditions is set, and which selects desired image-taking mode information from the set image-taking mode information; color convergence parameter storage means which stores color convergence parameter values which contain position data indicative of a position of a predetermined color in a color-difference plane, correction range setting data for setting to a correction range a predetermined range centered at the position of the predetermined color, and convergence coefficient data for converging a particular color corresponding to the correction range to the position indicative of the predetermined color, color convergence parameter setting means which selects and sets color convergence parameter values for the corresponding particular color from the color convergence parameter storage means on the basis of the image-taking mode information selected by the image-taking mode selection means; particular-color extraction means which extracts a video signal of a particular color from a video signal on the basis of the image-taking information selected by the image-taking mode selection means; luminance correction means which corrects a luminance level of the video signal according to a luminance level in the video signal of the particular color extracted by the particular-color extraction means; and color convergence correction processing means which corrects the particular color in the video signal into the predetermined color on the basis of a correction amount calculated on the basis of the color convergence parameter values set by the color convergence parameter setting means.

(6) The image capture apparatus described in (5), characterized in that the luminance correction means calculates a proportion of the video signal of the particular color in the video signal and corrects the luminance level of the video signal of the particular color according to the calculated proportion.

(7) The image capture apparatus described in (5), characterized in that the correction range setting data of the color convergence parameter storage means is data for setting to the correction range a circular or elliptical range centered at the position of the predetermined color in the color-difference plane.

(8) The image capture apparatus described in (5), characterized in that the color convergence parameter storage means is provided with a function which changes the color convergence parameter values.

(9) The image capture apparatus described in (5), characterized in that the image-taking mode selection means is provided with a function which automatically selects the image-taking mode information according to image-taking environments.

(10) The image capture method including:

an image-taking mode selection step of selecting desired image-taking mode information from image-taking mode information in which image-taking mode information containing information on particular colors determined according to predetermined image-taking conditions is set;

a particular-color extraction step of extracting a video signal of a particular color from a video signal on the basis of the image-taking mode information selected in the image-taking mode selection step;

a color-difference detection step of detecting color-difference data on the particular color from the video signal of the particular color extracted in the particular-color extraction step;

a color correction value calculation step of selecting correction reference data on the corresponding particular color from correction reference data storage means which stores correction reference data which is a reference for correcting the particular color into a predetermined color, on the basis of the image-taking mode information selected in the image-taking mode selection step, and calculating a color correction value for correcting the corresponding particular color into the predetermined color on the basis of the selected correction reference data and the color-difference data on the particular color detected by the color-difference detection step; and

a color correction processing step of correcting the particular color of the video signal into the predetermined color on the basis of the color correction value calculated in the color correction value calculation step.

In the image capture apparatus having the above-mentioned configuration, color convergence parameter values for a corresponding particular color from the color convergence parameter means are selected and set on the basis of selected image-taking mode information. Then, a correction amount necessary to converge the corresponding particular color to a position of a particular color (such as a memory color) in a color-difference plane is calculated on the basis of the color convergence parameter values, and a particular color in a video signal is corrected into the particular color (such as a memory color) according to the calculated correction amount. Accordingly, it is possible to correct the particular color with the correction amount corresponding to image-taking environments or a captured video image, without influencing colors not to be corrected.

In addition, since the luminance level of a video signal is corrected according to a luminance level in a video signal of a particular color or since the proportion of the video signal of the particular color in the video signal is calculated and the luminance of the particular color is corrected according to the calculated proportion, it is possible to correct the particular color of the corresponding particular color according to image-taking environments or a captured video image.

### BRIEF DESCRIPTION OF THE DRAWINGS

FIG. 1 is a block diagram schematically showing a configuration of essential sections for performing color correction processing in an image pickup apparatus according to the present invention.

FIG. 2 is an explanatory view for explaining correction target ranges of particular colors in a color-difference plane.

FIGS. 3A and 3B are explanatory views for explaining circular and elliptical correction target ranges shown in FIG. 2.

FIG. 4A is an explanatory view for explaining a method of calculating a direct distance s from center-point coordinates (xc, yc) in the correction target range shown in FIG. 2.

FIG. 5 is a graph showing a relationship between the direct distance s from center-point coordinates (xc, yc), a convergence coefficient γ, and a gain amount gain(s, γ).

FIG. 6 is an explanatory view showing one example of a data table provided in the image capture apparatus shown in FIG. 1.

FIG. 7 is a flowchart showing a process of color correction processing in the image capture apparatus shown in FIG. 1. FIG. 8 is a block diagram schematically showing a configuration of essential sections for color correction processing in a prior art image capture apparatus.

### BEST MODE FOR CARRYING OUT THE INVENTION

An embodiment of an image pickup apparatus according to the present invention will be described below with reference to the accompanying drawings. However, the drawings are referred to by way of illustration only, and are not intended to restrict the technical scope of the invention.

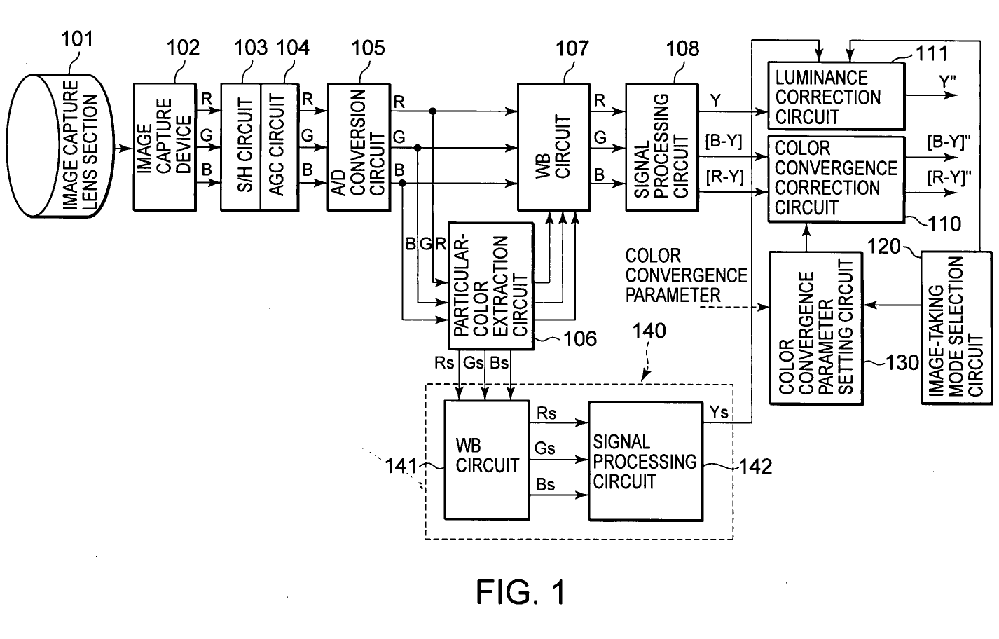

FIG. 1 is a block diagram showing a schematic configuration of essential sections for performing color signal correction processing in the image pickup apparatus. The schematic configuration is provided with an image capture lens section 101, an image capture device 102, a S/H (Sample/Hold) circuit 103, an AGC (Automatic Gain Control) circuit 104, an A/D (Analog/Digital) conversion circuit 105, a particular-color extraction circuit 106, a WB (White Balance) circuit 107, a signal processing circuit 108, a color convergence correction circuit 110, a luminance correction circuit 111, an image-taking mode selection circuit 120, a color convergence parameter setting circuit 130, a particular-color signal processing section 140, and the like.

The image capture lens section 101 receives light from an object and transmits the light to the image capture device 102.

A plurality of pixels which convert light to electrical signals (for example, in a CCD (Charge Coupled Device)) are arrayed in the image capture device 102, and the light from the object which passes through the image capture lens section 101 is converted to electrical signals by the individual pixels and the image capture-device 102 transmits the electrical signals to the S/H (Sample/Hold) circuit 103 as an analog video signal.

The S/H circuit 103 samples the analog video signal transmitted from the image capture device 102 and transmits sampled values to the AGC circuit 104, and holds the sampled values until the processing of the A/D conversion circuit 105 comes to an end. When this processing comes to an end, the S/H circuit 103 transmits the next sampled values to the AGC circuit 104.

The AGC circuit 104 amplifies the analog video signal sampled by the S/H circuit 103, and transmits the amplified analog video signal to the A/D conversion circuit 105.

The A/D conversion circuit 105 converts the analog video signal amplified by the AGC circuit 104 to digital video signals (R[red]/G[green]/B[blue]) and transmits the digital video signals to the particular-color extraction circuit 106 and the WB circuit 107.

The particular-color extraction circuit 106 extracts video signals of a particular color to be subjected to color correction (hereinafter referred to as particular-color signals (Rs[red]/Gs[green]/Bs[blue]) from the digital video signals (R[red]/G[green]/B[blue]) transmitted from the A/D conversion circuit 105, on the basis of image-taking mode information from the image-taking mode selection circuit 120 which will be described later, and calculates a controlled variable of white balance and transmits the calculated controlled variable to the WB circuit 107, and also transmits the extracted particular-color signals (Rs[red]/Gs[green]/Bs[blue]) to a WB circuit 141 of the particular-color signal processing section 140.

When the particular-color extraction circuit 106 is to extract the video signals of the particular color, the particular-color extraction circuit 106 changes a particular-color extraction range according to the luminance level of the video signals (R[red]/G[green]/B[blue]) to detect the video signals of the particular color.

The WB (White Balance) circuit 107 corrects the white balance of the video signals (R[red]/G[green]/B[blue]) transmitted from the A/D conversion circuit 105, in accordance with the controlled variable calculated by the particular-color extraction circuit, and transmits the corrected video signal to the signal processing circuit 108.

The signal processing circuit 108 converts the video signals (R[red]/G[green]/B[blue]) transmitted from the WB circuit 107 into a luminance signal Y and a color-difference signal [B−Y] and a color-difference signal [R−Y]. Then, the signal processing circuit 108 transmits the converted color-difference signal [B−Y] and the converted color-difference signal [R−Y] to the color convergence correction circuit 110 and also transmits the converted luminance signal Y to the luminance correction circuit 111.

The color convergence correction circuit 110 calculates a correction amount for correcting the corresponding particular color into a predetermined color (such as a memory color) on the basis of color convergence parameter values set by a color convergence parameter setting circuit 130 which will be described later, performs color convergence correction processing on the corresponding particular color in the color-difference signal [B−Y] and the color-difference signal [R−Y] transmitted from the signal processing circuit 108, in accordance with the calculated correction amount, and transmits a corrected color-difference signal [B−Y]” and a corrected color-difference signal [R−Y]” subjected to the color convergence correction procession, to the next-stage circuit.

The luminance correction circuit 111 corrects the luminance level of the luminance signal Y transmitted from the signal processing circuit 108, on the basis of the image-capture mode information from the image-taking mode selection circuit 120 and the luminance signal Ys of the particular color converted by a signal processing circuit 142 of the particular-color signal processing section 140, and transmits a corrected luminance signal Y″ to the next-stage circuit.

The luminance correction circuit 111 also calculates the proportion of the particular color in the entire captured video signals (R[red]/G[green]/B[blue]) (the entire image frame), and corrects the luminance level of the corresponding particular color according to the calculated proportion.

The image-taking mode selection circuit 120 has a plurality of image-taking modes which are set in advance according to image-taking conditions, scenes and the like (such as a sea, a night view, a portrait and a landscape), and is able to select a desired image-taking mode.

When an image taking mode is selected, the image-taking mode selection circuit 120 transmits image-taking mode information corresponding to the selected image-taking mode to predetermined sections inside the apparatus, such as the particular-color extraction circuit 106, the color convergence parameter setting circuit 130, the luminance correction circuit 111, and the like.

The image-taking mode information contains information such as information on a particular color to be subjected to color correction determined according to the image-taking mode and the information necessary to automatically perform various settings such as focus and white balance.

It should be noted that the image-taking mode selection circuit 120 can be adapted to automatically select an appropriate image-taking mode according to image-taking environments such as ambient brightness and the state of a light source, and can also be adapted to switch between automatic selection and manual selection.

The color convergence parameter setting circuit 130 is provided with a data table in which are stored color correction parameter values for converging and correcting particular colors into predetermined colors according to the respective image-taking modes, and selects color convergence parameter values for the corresponding particular color from the data table on the basis of image-taking mode information from the image-taking mode selection circuit 120 and sets the selected color convergence parameter values in the color convergence correction circuit 110.

For example, parameter values for color-correcting particular colors into colors which humans latently memorize and feel to be the most beautiful (hereinafter referred to as memory colors) are stored.

The color convergence parameter values stored in the data table of the color convergence parameter setting circuit 130 will be described below.

A position (coordinates) at which a predetermined color to be converged, such as a memory color, exists, in a color-difference plane is fixed, and a color which exists in a predetermined range centered at the position (coordinates) at which the predetermined color (such as a memory color) exists (hereinafter referred to as a correction target range) is a color to be corrected, i.e., a particular color.

The particular color is distributed in a circular or elliptical shape centered at the predetermined color such as a memory color, so that it is possible to highly accurately correct only a desired particular color by setting to the correction target range a circular or elliptical range centered at the position (coordinates) of the predetermined color (such as a memory color) in the color-difference plane.

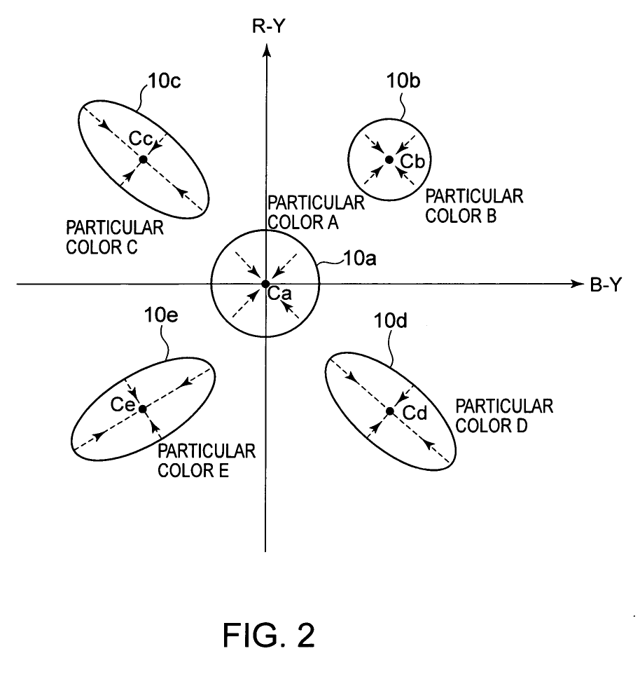

As shown in FIG. 2 by way of example, in a color-difference plane (two-dimensional coordinates represented by a vertical axis indicative of a color difference [R−Y] and a horizontal axis indicative of a color difference [B−Y]), a particular color “A” is distributed in a circular range 10a centered at a position (coordinates) Ca of a memory color a, a particular color “B” is distributed in a circular range 10b centered at a position (coordinates) Cb of a memory color b, a particular color “C”, is distributed in an elliptical range 10c centered at a position (coordinates) Cc of a memory color c, a particular color “D” is distributed in an elliptical range 10d centered at a position (coordinates) Cd of a memory color d, and a particular color “E” is distributed in a circular range 10e centered at a position (coordinates) Ce of a memory color e. The respective circular or elliptical ranges corresponding to the memory colors a to e are set to correction target ranges 10a to 10e.

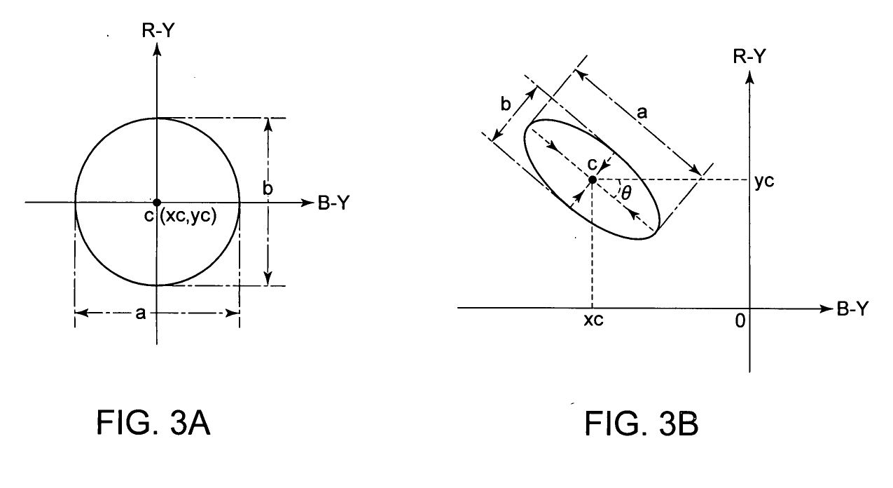

Each of the circular or elliptical correction target ranges is associated with the image-taking mode information, and is stored in the data table as parameter values which respectively indicate the center-point coordinates (xc, yc) of the circle or the ellipse, the lengths (a, b) of its major and minor axes, and its inclination (rotational direction) θ, as shown in FIGS. 3A and 3B.

The center-point coordinates (xc, yc) are coordinate data on a predetermined color (such as a memory color) in the color-difference plane, and are represented by a distance x in the direction of the color difference [B−Y] from the origin “0” of the color-difference plane and a distance y in the direction of the color difference [R−Y] from the origin “0” of the color-difference plane. For example, in FIG. 3A, the center-point coordinates (xc, yc) are (0, 0), and in FIG. 3B, the center-point coordinates (xc, yc) are (x, y).

The lengths (a, b) of the major and minor axes are data indicative of the lengths of the diameters of the circle or ellipse in the color-difference plane, and as shown in FIG. 3B, the length of the longest diameter that passes through the center-point coordinates (xc, yc) is represented as the major axis a, while the length of the shortest diameter that passes through the center-point coordinates (xc, yc) is represented as the minor axis b. As shown in FIG. 3A, if the correction target range is a circle, the major and minor axes have the same length (a=b).

The inclination θ is data indicative of the inclination (rotational direction) of the ellipse in the color-difference plane as shown in FIG. 3B. As shown in FIG. 3A, if the correction target range is a circle, the inclination (rotational direction) θ is zero.

Stored in the data table are not only the parameter values about the correction target range (the center-point coordinates (xc, yc), the lengths (a, b) of the major and minor axes, and the inclination θ) but also a convergence coefficient γ for calculating a correction amount for correcting a particular color into the position (coordinates) of a predetermined color (such as a memory color) (hereinafter referred to as a gain amount), i.e., the gain amount for converging the particular color to the center-point coordinates (xc, yc).

The convergence coefficient γ is a coefficient value found by evaluating colors of various images, and is a coefficient value to be used when the gain amount for converging a particular color in the color-difference plane into a predetermined color (such as a memory color) on the basis of the following equations 1 and 2.
s=\sqrt{(b−y)²+(r−y)²} Equation 1

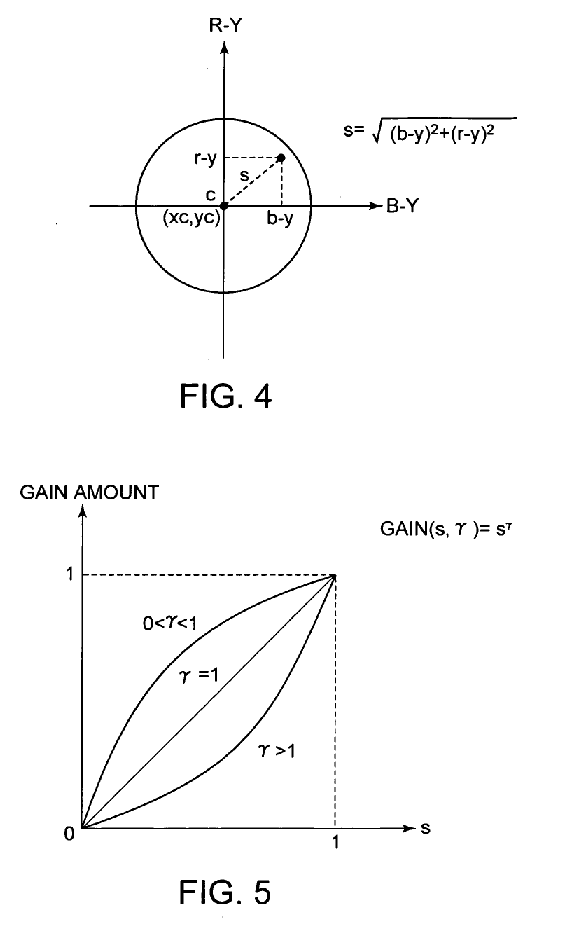

In equation 1, “s”, “b−y” and “r−y” respectively represent: s; a direct distance from the center-point coordinates (xc, yc), b−y; a distance in the direction of the color difference [B−Y] from the center-point coordinates (xc, yc), and r−y; a distance in the direction of the color difference [R−Y] from center-point coordinates (xc, yc), as shown in FIG. 4.
gain(s,γ)=S^{γ} Equation 2

In equation 2, s is a direct distance from the center-point coordinates (xc, yc), γ is a convergence coefficient, and gain(s, γ) is a gain amount (correction amount).

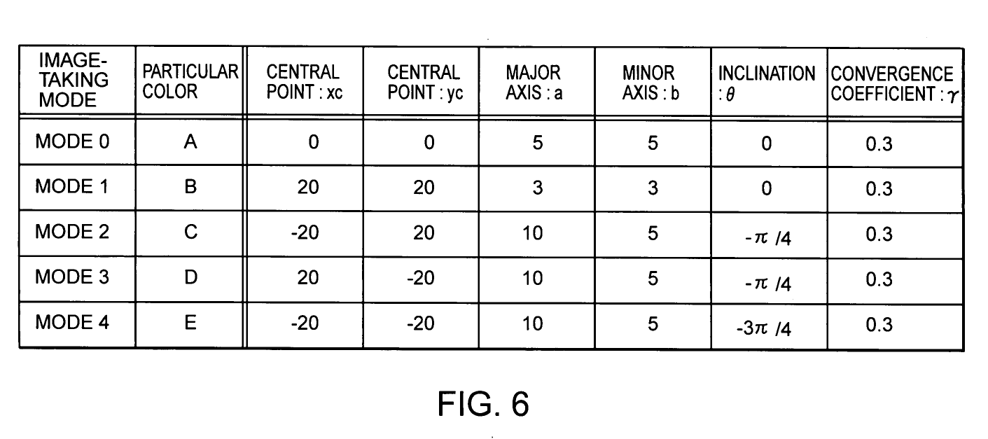

FIG. 5 is a normalized graph in which the direct distance s from the center-point coordinates (xc, yc) to the power of the convergence coefficient γ is associated with the gain amount gain(s, γ), and is divided into “0<γ<1”, “γ=1”, and “γ>1” according to the value of the convergence coefficient γ.

Thus, the gain amount corresponding to the position (coordinates) of the predetermined color distributed in the correction target range, i.e., the gain amount gain(s, γ) corresponding to the distance s, is calculated by selecting and setting one of convergence coefficients γ corresponding to predetermined colors (such as memory colors).

In addition, the above-mentioned equations 1 and 2 are equations for calculating the distance s and the gain amount gain(s, γ) when the correction target range is a circle, but in the case of the elliptical correction target range shown in FIG. 3B, the transformation ratio at which a predetermined circle which is used as a reference is transformed into the corresponding ellipse is found and the values of the distance s and the gain amount gain(s, γ) of the reference circle are corrected according to the transformation ratio.

In this manner, the correction target ranges (the center-pointed coordinates (xc, yc), the lengths of major axis and minor axis (a, b) and the inclination θ) and the convergence coefficients γ which are respectively associated with the particular colors set according to the respective image-taking modes are stored in the data table as the color convergence parameter values.

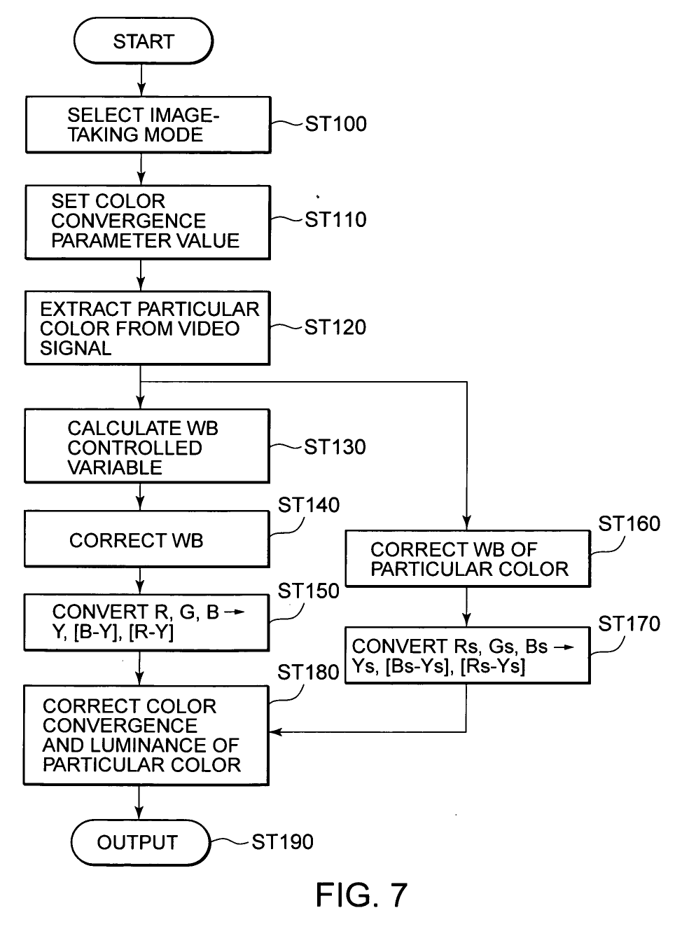

FIG. 6 schematically shows one example of the data table. In the row of an image-taking mode 0, color convergence parameter values such as a particular color “A”, the center-point coordinates (xc, yc)→(0, 0), the distance (length) of the major axis a→5, the distance (length) of the minor axis b→5, the inclination θ→“0”, the convergence coefficient γ→“0.3” are stored. In the row of an image-taking mode 1, color convergence parameter values such as a particular color “B”, the center-point coordinates (xc, yc)→(20, 20), the distance (length) of the major axis a→3, the distance (length) of the minor axis b→3, the inclination θ→“0”, and the convergence coefficient γ→“0.3” are stored. In the row of an image-taking mode 2, color convergence parameter values such as a particular color C, the center-point coordinates (xc, yc)→(−20, 20), the distance (length) of the major axis a=10, the distance (length) of the minor axis b→5, the inclination θ→−π/4, and the convergence coefficient γ→0.3 are stored. In the row of an image-taking mode 3, color convergence parameter values such as a particular color “D”, the center-point coordinates (xc, yc)→(20, −20), the distance (length) of the major axis a→10, the distance (length) of the minor axis b→5, the inclination θ→“−π/4”, and the convergence coefficient γ→“0.3” are stored. In the row of an image-taking mode 4, color convergence parameter values such as a particular color “E”, the center-point coordinates (xc, yc)→(−20, −20), the distance (length) of the major axis a→10, the distance (length) of the minor axis b→5, the inclination θ→“−3π/4”, and the convergence coefficient γ→“0.3” are stored.

In addition, the color convergence parameter values of the data table can be changed. For example, in the case of an apparatus capable of acquiring data from a recording medium such as a memory card, the color convergence parameter values can be changed to different color convergence parameter values recorded on the recording medium (such as a memory card), or in the case of an apparatus connectable to a communication network, the color convergence parameter values can be changed to color convergence parameter values acquired via the communication network. Accordingly, users can change the color convergence parameter values to color convergence parameter values which can provide colors or hues suited to the preferences of the users, or can individually customize the color convergence parameter values according to the users.

The particular-color signal processing section 140 is provided with the WB (White Balance) circuit 141, the signal processing circuit 142 and the like.

The WB (White Balance) circuit 141 of the particular-color signal processing section 140 corrects the white balance of the particular-color signals, (Rs[red]/Gs[green]/Bs[blue]) extracted by the particular-color extraction circuit 106 and transmits the corrected particular-color signals to the signal processing circuit 142.

The signal processing circuit 142 of the particular-color signal processing section 140 converts the particular-color signals (Rs[red]/Gs[green]/Bs[blue]) transmitted from the WB circuit 141 into a luminance signal Ys and a color-difference signal [B−Y] and a color-difference signal [R−Y], and transmits the converted luminance signal Ys to the luminance correction circuit 111.

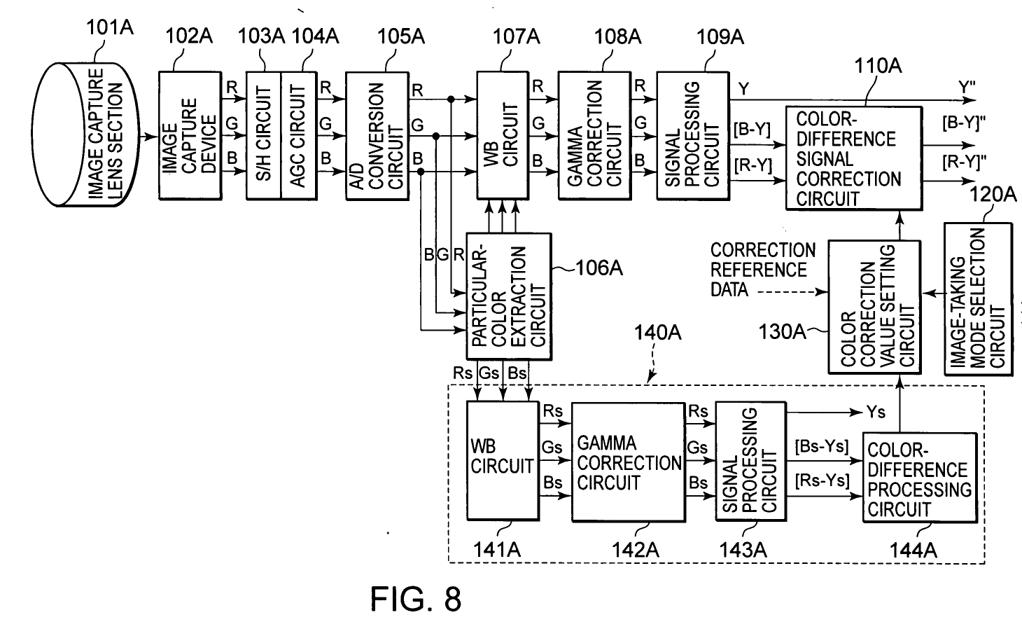

The process of color correction processing in an image capture apparatus 100 having the above-mentioned configuration will be described below with reference to FIG. 7.

First, when a photographer selects a desired image-taking mode via the image-taking mode selection circuit 120 or an image-taking mode is automatically selected according to an image-taking environment, image-taking mode information corresponding to the selected image-taking mode is transmitted to predetermined sections inside the apparatus (the particular-color extraction circuit 106, the color convergence parameter setting circuit 130, the luminance correction circuit 111, and the like) (ST100).

The color convergence parameter setting circuit 130 selects color convergence parameter values for the corresponding particular color from the data table on the basis of the image-taking mode information transmitted from the image-taking mode selection circuit 120, and sets the selected color convergence parameter values in the color convergence correction circuit 110 (ST110).

In addition, in each of the predetermined sections inside the apparatus other than the color convergence parameter setting circuit 130, various settings such as focus and white balance are automatically performed on the basis of the image-taking mode information corresponding to the image-taking mode.

When image taking is started, light inputted from an object via the image capture lens section 101 is converted into an electrical signal by the image capture device 102, and the electrical signal passes through the S/H circuit 103 and the AGC circuit 104 and is converted into digital video signals (R[red]/G[green]/B[blue]) by the A/D conversion circuit 105. The digital video signals are transmitted to the particular-color extraction circuit 106 and the WB (White Balance) circuit 107.

The particular-color extraction circuit 106 extracts particular-color signals (Rs[red]/Gs[green]/Bs[blue]) from the video signals (R[red]/G[green]/B[blue]) transmitted from the A/D conversion circuit 105, on the basis of the image-taking mode information selected by the image-taking mode selection circuit 120, and calculates a controlled variable of white balance and transmits the controlled variable to the WB (White Balance) circuit 107, and also transmits the extracted particular-color signals (Rs[red]/Gs[green]/Bs[blue]) to the WB (White Balance) circuit 141 of the particular-color signal processing section 140 (ST120, ST130).

First of all, the processing process of the video signals (R[red]/G[green]/B[blue]) will be described below.

The WB circuit 107 determines color temperatures of the video signals (R[red]/G[green]/B[blue]) transmitted from the A/D conversion circuit 105, and corrects the white balance of the video signals (R[red]/G[green]/B[blue]) on the basis of the controlled variable of white balance calculated by the particular-color extraction circuit 106 and transmits the corrected video signals to the signal processing circuit 108 (ST140).

Then, the signal processing circuit 108 converts the video signals (R[red]/G[green]/B[blue]) corrected for white balance into a luminance signal Y and a color-difference signal [B−Y] and a color-difference signal [R−Y], and transmits the converted luminance signal Y to the luminance correction circuit 111 and the converted color-difference signals [B−Y] and the converted color-difference signal [R−Y] to the color convergence correction circuit 110 (ST150).

The processing process of the particular-color signals (Rs[red]/Gs[green]/Bs[blue]) which is executed in parallel with the above-mentioned process of the video signals (R[red]/G[green]/B[blue]) will be described below.

The WB circuit 141 of the particular-color signal processing section 140 determines color temperatures of the particular-color signals (Rs[red]/Gs[green]/Bs[blue]) extracted by the particular-color extraction circuit 1066, and corrects the white balance of the particular-color signals (Rs[red]/Gs[green]/Bs[blue]) and transmits the corrected particular-color signals to the signal processing circuit 142 (ST160).

Then, the signal processing circuit 142 of the particular-color signal processing section 140 converts the particular-color signals (Rs[red]/Gs[green]/Bs[blue]) corrected for white balance into a luminance signal Ys and a color-difference signal [Bs−Ys] and a color-difference signal [Rs−Ys], and transmits the luminance signal Ys to the luminance correction circuit 111 (ST170).

After the processing of the video signals (R[red]/G[green]/B[blue]) and the particular-color signals (Rs[red]/Gs[green]/Bs[blue]), color correction processing of the particular color is performed by the color convergence correction circuit 110 and the luminance correction circuit 111.

The color convergence correction circuit 110 calculates a gain amount (correction amount) for correcting the corresponding particular color into a predetermined color (such as a memory color) on the basis of the color convergence parameter values set by the color convergence parameter setting circuit 130 and performs color convergence correction processing of the corresponding particular color in the color-difference signals [B−Y] and [R−Y] transmitted from the signal processing circuit 108, on the basis of the calculated gain amount, and transmits the color-difference signal [B−Y]” and the color-difference signal [R−Y]” corrected for color convergence to the next-stage circuit (ST180, ST190).

Specifically, first, the color convergence correction circuit 110 calculates the gain amount gain(s, γ) by the above-mentioned equations 1 and 2 on the basis of the color convergence parameter values (the center-point coordinates (xc, yc), the lengths (a, b) of the major and minor axes, the inclination θ, and the convergence coefficient γ) set by the color convergence parameter setting circuit 130.

Then, the color convergence correction circuit 110 performs the color convergence correction processing by performing multiplication processing on the calculated gain amount gain(s, γ) and the color-difference signals [B−Y] and [R−Y] transmitted from the signal processing circuit 108, on the basis of the following equation 3. Namely, the corresponding particular color in the video signals is converged to the position of the predetermined color (such as a memory color) in the color-difference plane.
[B−Y]″=gain(s,γ)*[B−Y] Equation 3
[R−Y]″=gain(s,γ)*[R−Y]

In the meantime, the luminance correction circuit 111 corrects the luminance level of the luminance signal Y transmitted from the signal processing circuit 108, on the basis of the image-taking mode information from the image-taking mode selection circuit 120 and the luminance signal Ys converted by the signal processing circuit 142 of the particular-color signal processing section 140, and outputs the corrected luminance signal Y to the next-stage circuit (ST180, ST190).

The luminance correction circuit 111 is also able to calculate the proportion of the particular color in the entire captured video signals (R[red]/G[green]/B[blue]) (the entire image frame) and change a correction amount for the luminance level of the particular color according to the calculated proportion.

For example, in an image-taking mode for taking a portrait image, if a flesh color of a person is to be corrected, the proportion occupied in the entire image (image frame) by the flesh color which is a particular color is determined, and if the proportion is larger than a predetermined proportion, the correction amount for the luminance level of the flesh color is increased, whereas if the proportion is smaller than the predetermined proportion, the correction amount for the luminance level is decreased.

In this manner, it is possible to correct a color-corrected particular color into a far more preferable color by changing the correction amount for the luminance level of a particular color according to image-taking circumstances during even the same image-taking mode.

As described hereinabove, the image capture apparatus selects and sets a color convergence parameter value for a particular color from among previously stored color convergence parameter values, on the basis of automatically or manually selected image-taking mode information. In a correction range set by this color convergence parameter value, the particular color is distributed in a circular or elliptical shape centered at a predetermined color such as a memory color, so that a circular or elliptical range centered at the position (coordinates) of the particular color (such as a memory color) in a color-difference plane can be set to a correction range to highly accurately correct only the particular color.

When image taking is started, a correction amount necessary to converge the corresponding particular color to the position of the predetermined color (such as a memory color) in the color-difference plane is calculated on the basis of the color convergence parameter value, and the particular color in video signals can be corrected into the predetermined color (such as a memory color) in accordance with the calculated correction amount, whereby it is possible to achieve the superior advantage of correcting a particular color by a correction amount corresponding to image-taking circumstances or a captured video image, without influencing colors not to be corrected.

In addition, if the proportion occupied by a particular color in the entire captured video signal (the entire image frame) is calculated and a correction amount for the luminance level of the particular color is changed according to the calculated proportion, it is possible to achieve the superior advantage of correcting the particular color of the captured video signal into a luminance which can provide a preferable color corresponding to image-taking circumstances or a captured video image.

1. An image capture apparatus, comprising:
image-taking mode selection means, in which image-taking mode information containing information on a particular color determined according to a predetermined image-taking condition is set, for selecting desired image-taking mode information from the set image-taking mode information;
color convergence parameter storage means for storing a color convergence parameter value containing position data indicative of a position of a predetermined color in a color-difference plane, correction range setting data for setting to a correction range a predetermined range centered at the position of the predetermined color, and convergence coefficient data for converging a particular color corresponding to the correction range to the position indicative of the predetermined color;
color convergence parameter setting means for selecting and setting a color convergence parameter value for the corresponding particular color from the color convergence parameter storage means on a basis of the image-taking mode information selected by the image-taking mode selection means; and
color convergence correction processing means for correcting a particular color in a video signal into the predetermined color on a basis of a correction amount calculated on a basis of the color convergence parameter value set by the color convergence parameter setting means.

2. The image capture apparatus according to claim 1, characterized in that the correction range setting data of the color convergence parameter storage means is data for setting to the correction range a circular or elliptical range centered at the position of the predetermined color in the color-difference plane.

3. The image capture apparatus according to clam 1, characterized in that the color convergence parameter storage means comprises a function for changing the color convergence parameter values.

4. The image capture apparatus according to clam 1, characterized in that the image-taking mode selection means comprises a function for automatically selecting the image-taking mode information according to an image-taking environment.

5. An image capture apparatus, comprising:
image-taking mode selection means, in which image-taking mode information containing information on a particular color determined according to a predetermined image-taking condition is set, for selecting desired image-taking mode information from the set image-taking mode information;
color convergence parameter storage means for storing a color convergence parameter value containing position data indicative of a position of a predetermined color in a color-difference plane, correction range setting data for setting to a correction range a predetermined range centered at the position of the predetermined color, and convergence coefficient data for converging a particular color corresponding to the correction range to the position indicative of the predetermined color;
color convergence parameter setting means for selecting and setting a color convergence parameter value for the corresponding particular color from the color convergence parameter storage means on a basis of the image-taking mode information selected by the image-taking mode selection means;
particular-color extraction means for extracting a video signal of a particular color from a video signal on a basis of the image-taking information selected by the image-taking mode selection means;
luminance correction means for correcting a luminance level of the video signal according to a luminance level in the video signal of the particular color extracted by the particular-color extraction means; and
color convergence correction processing means for correcting the particular color in the video signal into the predetermined color on a basis of a correction amount calculated on a basis of the color convergence parameter value set by the color convergence parameter setting means.

6. The image capture apparatus according to claim 5, characterized in that the luminance correction means calculates a proportion of the video signal of the particular color in the video signal and corrects the luminance level of the video signal of the particular color according to the calculated proportion.

7. The image capture apparatus according to claim 5, characterized in that the correction range setting data of the color convergence parameter storage means is data for setting to the correction range a circular or elliptical range centered at the position of the predetermined color in the color-difference plane.

8. The image capture apparatus according to claim 5, characterized in that the color convergence parameter storage means comprises a function for changing the color convergence parameter value.

9. The image capture apparatus according to claim 5, characterized in that the image-taking mode selection means comprises a function for automatically selecting the image-taking mode information according to an image-taking environment.

10. An image capture method, characterized by comprising:
an image-taking mode selection step of selecting desired image-taking mode information from image-taking mode information in which image-taking mode information containing information on a particular color determined according to a predetermined image-taking condition is set;
a particular-color extraction step of extracting a video signal of a particular color from a video signal on the basis of the image-taking mode information selected in the image-taking mode selection step;
a color-difference detection step of detecting color-difference data on the particular color from the video signal of the particular color extracted in the particular-color extraction step;
a color correction value calculation step of selecting correction reference data on the corresponding particular color from correction reference data storage means storing correction reference data which is a reference for correcting the particular color into a predetermined color, on a basis of the image-taking mode information selected in the image-taking mode selection step, and calculating a color correction value for correcting the corresponding particular color into the predetermined color on a basis of the selected correction reference data and the color-difference data on the particular color detected by the color-difference detection step; and
a color correction processing step of correcting the particular color of the video signal into the predetermined color on a basis of the color correction value calculated in the color correction value calculation step.
